(19) United States
(12) Patent Application Publication
(10) Pub. No.: US 2026/0367325 A1
(43) Pub. Date: Nov. 19, 2026

(54) WAVEGUIDES AND METHODS OF FORMING THE SAME

(71) Applicant: Taiwan Semiconductor Manufacturing Co., Ltd., Hsinchu (TW)

(72) Inventors: Su-Chun Yang, Hsinchu (TW); Chu-Chuan Huang, Hsinchu (TW); Chiao-Chun Chang, Hsinchu County (TW); Jih-Churng Twu, Hsinchu County (TW); Chung-Shi Liu, Hsinchu (TW); Chen-Hua Yu, Hsinchu (TW)

(21) Appl. No.: 19/750,406

(22) Filed: Jul. 22, 2026

Related U.S. Application Data
(62) Division of application No. 18/594,694, filed on Mar. 4, 2024.

(51) Int. Cl. G02B 6/13; G02B 6/122; G02B 6/136; G02B 6/12; G02B 6/132

(52) U.S. Cl. CPC G02B 6/13; G02B 6/122; G02B 6/136; G02B 2006/12038; G02B 6/132

(57) ABSTRACT

In an embodiment, a method includes: depositing a waveguide cladding layer over a substrate, the substrate having a center portion in a cross-sectional view and an edge portion adjacent the center portion in the cross-sectional view; reshaping the waveguide cladding layer to form a bevel profile in the waveguide cladding layer over the edge portion of the substrate; forming a recess in the waveguide cladding layer; depositing a waveguide core layer in the recess and over the waveguide cladding layer, the waveguide core layer extending along the bevel profile of the waveguide cladding layer; and planarizing the waveguide core layer and the waveguide cladding layer to form a waveguide core, the waveguide core including a portion of the waveguide core layer in the recess.

### CROSS-REFERENCE TO RELATED APPLICATIONS

This application is a divisional of U.S. Patent Application No. 18/594,694 filed on Mar. 4, 2024, which application is hereby incorporated herein by reference.

### BACKGROUND

Electrical signaling and processing are one technique for signal transmission and processing. Optical signaling and processing have been used in increasingly more applications in recent years, particularly due to the use of optical fiber-related applications for signal transmission. Optical signaling and processing are typically combined with electrical signaling and processing to provide full-fledged applications. For example, waveguides may be used for optical signal transmission. Optical signals within a waveguide may be controlled by an optical modulator, such as an optical phase shifter or the like.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-6 are cross-sectional views of intermediate stages in the manufacturing of waveguides, in accordance with some embodiments.

FIGS. 7A-7B illustrate a bevel cleaning module and an associated bevel process.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

According to various embodiments, waveguides are formed over a substrate. A waveguide includes a waveguide core as well as a surrounding portion of a cladding layer. A reshaping process is performed to alter a profile of the cladding layer, specifically, to form bevel profiles at the edges of the cladding layer. Forming the bevel profiles at the edges of the cladding layer may favorably affect cracking dynamics between the cladding layer and a waveguide core layer (for the waveguide cores). The risk of the cladding layer cracking may be reduced. On account of this reduced cracking risk, the cladding layer may be formed to a large thickness. Thus, the waveguide cores may have a large thickness, which may improve their optical performance.

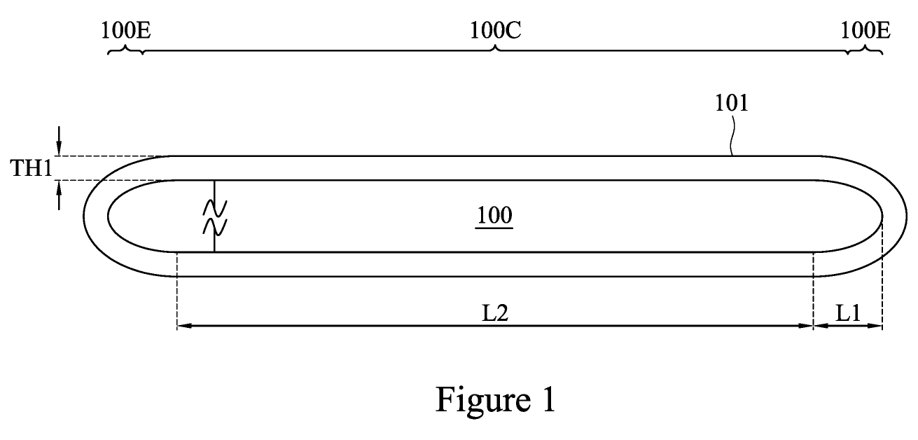

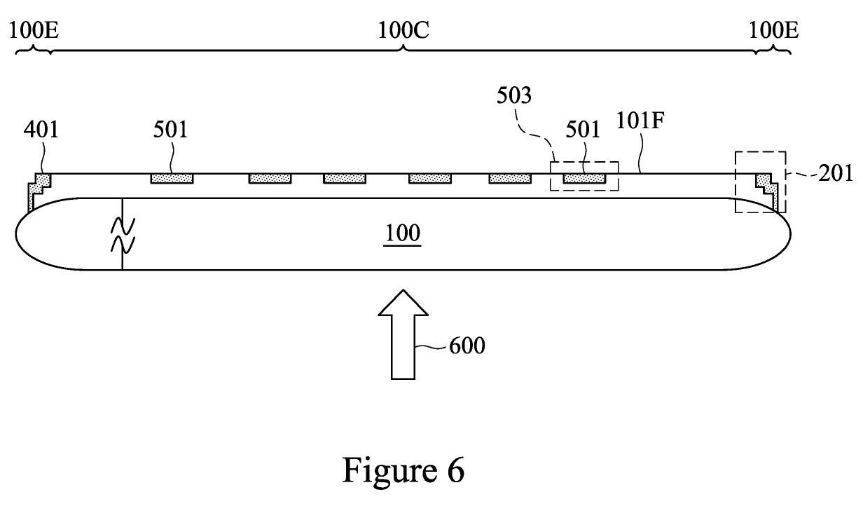

FIGS. 1-6 are cross-sectional views of intermediate stages in the manufacturing of waveguides 503 (see FIG. 6), in accordance with some embodiments. A waveguide 503 includes a portion of a waveguide cladding layer 101 and a waveguide core 501. As subsequently described in greater detail, a bevel profile of the waveguide cladding layer 101 will be reshaped before the waveguide cores 501 are formed. Specifically, the bevel profile of the waveguide cladding layer 101 is reshaped to reduce stress in the waveguide cladding layer 101, which may decrease the risk of cracking when depositing a waveguide core layer (for the waveguide cores 501). The manufacturing yield of the waveguides 503 may thus be increased. Reducing the risk of cracking allows the waveguide core layer to be deposited to a large thickness, which may improve the optical performance of the waveguides 503.

In FIG. 1, a substrate 100 is formed or provided. The substrate 100 may include a semiconductor substrate, such as a bulk semiconductor, an active layer of a semiconductor-on-insulator (SOI) substrate, or the like, which may be doped or undoped. The semiconductor substrate may include other semiconductor materials, such as germanium; a compound semiconductor including silicon carbide, gallium arsenic, gallium phosphide, indium phosphide, indium arsenide, and/or indium antimonide; an alloy semiconductor including silicon germanium, gallium arsenide phosphide, aluminum indium arsenide, aluminum gallium arsenide, gallium indium arsenide, gallium indium phosphide, and/or gallium indium arsenide phosphide; or combinations thereof. Other substrates, such as multi-layered or gradient substrates, may also be used. The substrate 100 may be a wafer.

The semiconductor substrate has an active surface (e.g., the surface facing upward in FIG. 1) and an inactive surface (e.g., the surface facing downward in FIG. 1). The active surface is at a front-side of the substrate 100, while the inactive surface is at a back-side of the substrate 100. Devices are at the active surface of the semiconductor substrate. The devices may be active devices (e.g., transistors, diodes, etc.), capacitors, resistors, etc. The inactive surface may be free from devices. The device may be formed in a suitable front-end of line (FEOL) process.

An interconnect structure (not separately illustrated) may be over the active surface of the semiconductor substrate. The interconnect structure interconnects the devices of the semiconductor substrate to form an integrated circuit. The interconnect structure may be formed in a suitable back-end of line (BEOL) process. The interconnect structure may include one or more dielectric layer(s) and respective metallization pattern(s) in the dielectric layer(s). Acceptable dielectric materials for the dielectric layers include oxides such as silicon oxide, aluminum oxide, or the like; nitrides such as silicon nitride, silicon oxynitride; combinations thereof; or the like. The dielectric layer(s) may be formed of a low-k (LK) dielectric material such as carbon-doped silicon oxide, an extremely low-k (ELK) dielectric material such as porous carbon-doped silicon oxide, or the like. Other acceptable dielectric materials may be utilized. The metallization patterns may include conductive vias and/or conductive lines to interconnect the devices of the semiconductor substrate. The metallization patterns may be formed of a conductive material, such as a metal, such as copper, cobalt, aluminum, gold, combinations thereof, or the like. The metallization patterns may be formed by a damascene process, such as a single damascene process, a dual damascene process, or the like.

The substrate 100, in the cross-sectional view, has an elongated oval shape. A center portion 100C of the substrate 100 has a rectangular shape in the cross-sectional view, while edge portions 100E of the substrate 100 have a rounded shape in the cross-sectional view. The substrate 100 may be circular in a top-down view (not separately illustrated), with the edge portions 100E extending around each side of the center portion 100C in the top-down view. Thus, the edge portions 100E are adjacent either side of the center portion 100C in the cross-sectional view.

A waveguide cladding layer 101 is formed over the substrate 100. Portions of the waveguide cladding layer 101 will be components of waveguides. The waveguide cladding layer 101 may be formed of a dielectric material that is suitable for optics. In some embodiments, the waveguide cladding layer 101 is formed of an oxide dielectric material, such as silicon oxide, germanium oxide, combinations of these, or the like, which may be formed using a deposition method such as chemical vapor deposition (CVD), atomic layer deposition (ALD), or the like. However, any suitable material and method of manufacture may be used to form the waveguide cladding layer 101. The waveguide cladding layer 101 may be formed to any suitable thickness TH1. In some embodiments, the waveguide cladding layer 101 is formed to a thickness TH1 in the range of 2.0 µm to 4.0 µm (such as about 2.5 µm).

The edge portions 100E of the substrate 100 each have a first length L1 in the cross-sectional view. In some embodiments, the first length L1 is in a range of 0.2 mm to 3.0 mm. If the first length L1 of the edge portions 100E is less than 0.2 mm, then there may not be adequate space to form desired geometries (subsequently described) of the waveguide cladding layer 101 over the edge portions 100E of the substrate 100. If the first length L1 of the edge portions 100E is greater than 3.0 mm, then the center portion 100C of the substrate 100 may be too small to accommodated desired devices. The center portion 100C of the substrate 100 has a second length L2 in the cross-sectional view. In some embodiments, the second length L2 is in a range of 280 mm to 299.6 mm.

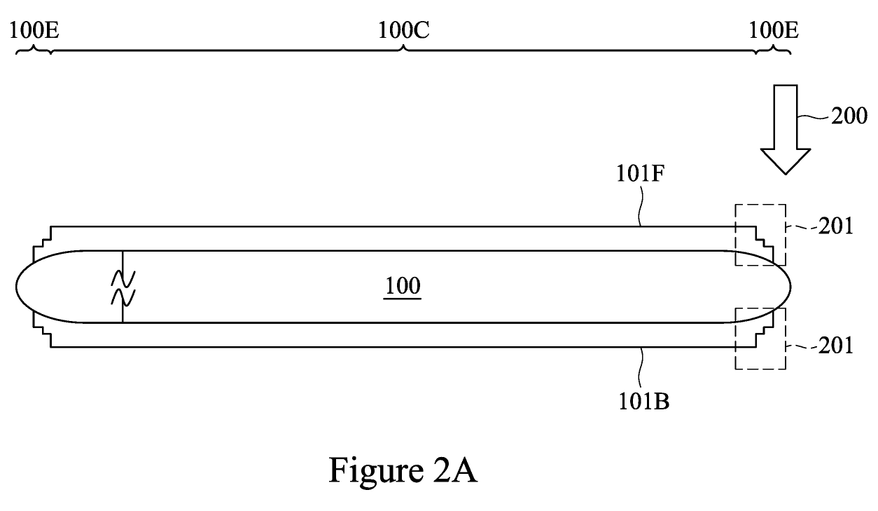

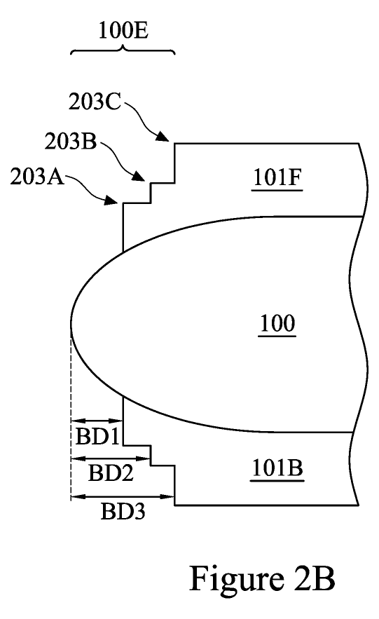

In FIG. 2A, a profile of the waveguide cladding layer 101 (in the cross-sectional view) is reshaped by a bevel process 200. The waveguide cladding layer 101 is removed from the outer edge of the substrate 100 by the bevel process 200. As a result, the waveguide cladding layer 101 is divided into a front-side waveguide cladding layer 101F (which remains on the front-side of the substrate 100) and a back-side waveguide cladding layer 101B (which remains on the back-side of the substrate 100). The front-side waveguide cladding layer 101F and the back-side waveguide cladding layer 101B may be collectively referred to as the waveguide cladding layers 101.

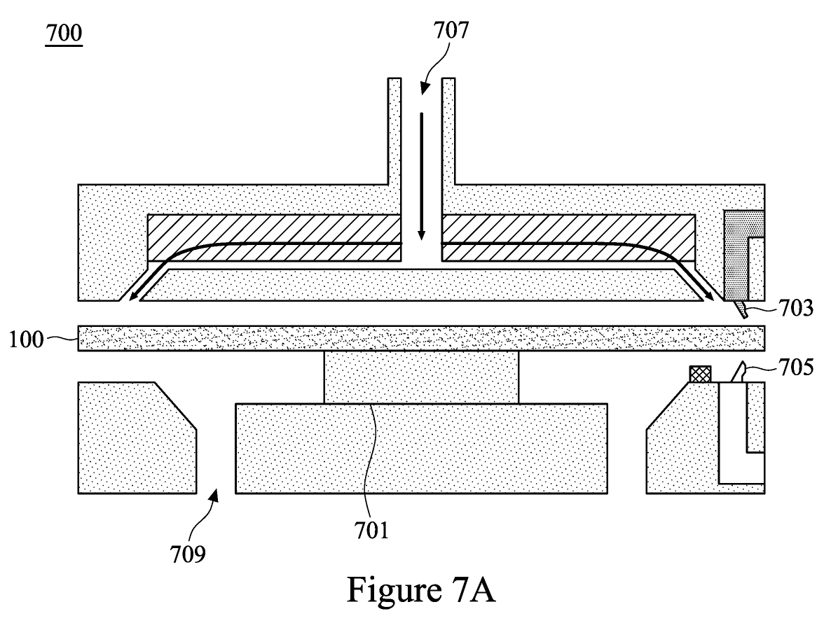

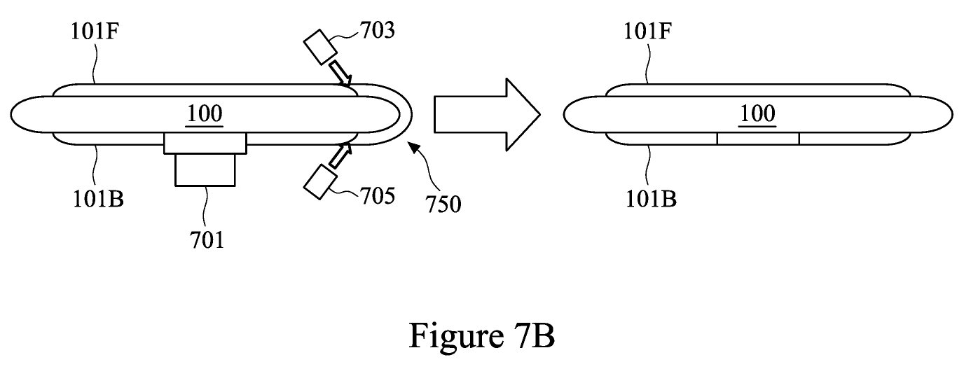

The bevel process 200 modifies the geometries of the waveguide cladding layers 101 where it overlaps the edge portions 100E of the substrate 100, to form bevel profiles 201 at the outer edges of the waveguide cladding layers 101. The bevel process 200 may include an oxide clean process. The oxide clean process may include an etching process such as a wet etch, performed using a suitable cleaning solution. The etching process may be performed in multiple steps such that various portions of the waveguide cladding layers 101 are removed during each step of the etching process to form desired geometries for the waveguide cladding layers 101 overlapping the edge portions 100E of the substrate 100. The bevel process 200 will be subsequently described in greater detail for FIGS. 7A-7B.

The outer edges of the front-side waveguide cladding layer 101F and the back-side waveguide cladding layer 101B are reshaped by the bevel process 200. After the bevel process 200, the outer edges of the substrate 100 extend beyond the outer edges of the waveguide cladding layers 101. The distance between an outer edge of the substrate 100 and a corresponding outer edge of a waveguide cladding layer 101 may be referred to as a “bevel depth” of that waveguide cladding layer 101. In the illustrated embodiment, a bevel depth of the front-side waveguide cladding layer 101F is substantially equal (within process variations) to a bevel depth of the back-side waveguide cladding layer 101B. In another embodiment, a bevel depth of the front-side waveguide cladding layer 101F is different than a bevel depth of the back-side waveguide cladding layer 101B. For example, a bevel depth of the front-side waveguide cladding layer 101F may be larger than a bevel depth of the back-side waveguide cladding layer 101B. In some embodiments, the smallest bevel depth of the front-side waveguide cladding layer 101F is about 1 nm, while the smallest bevel depth of the back-side waveguide cladding layer 101B is about 0.2 mm.

FIG. 2B is a detailed view showing bevel profiles 201 of the waveguide cladding layers 101, following the bevel process 200. In this example, each bevel profile 201 is a stairstep profile having multiple stairsteps 203. For example, a stairstep profile includes a first stairstep 203A, a second stairstep 203B, and a third stairstep 203C. Each stairstep 203 may have its own bevel depth, with the bevel depths increasing in a direction extending away from the substrate 100. In some embodiments, the first stairstep 203A has a first bevel depth BD1 in the range of 0.5 mm to 1.5 mm (such as about 1 mm), the second stairstep 203B has a second bevel depth BD2 in the range of 1.8 mm to 2.5 mm (such as about 2 mm), and the third stairstep 203C has a third bevel depth BD3 in the range of 2.8 mm to 5 mm (such as about 3 mm). If the bevel depths of the stairsteps 203 are too great, then an insufficient quantity of stairsteps may be formed over the edge portions 100E of the substrate 100 in the waveguide cladding layers 101. If the bevel depths are too small then a distinct stairstep profile may not be achieved.

Although the stairstep profile illustrated in FIG. 2B depicts a three-stairstep profile, this is merely one example of the stairstep profile. The stairstep profile may have any number of stairsteps 203. Additionally, the stairstep profile is merely one example of the bevel profile 201, and any suitable bevel profile may be formed for the waveguide cladding layers 101. For example, the bevel profiles 201 maybe sloped profiles, each of which has a bevel depth that increases continually in a direction extending away from the substrate 100.

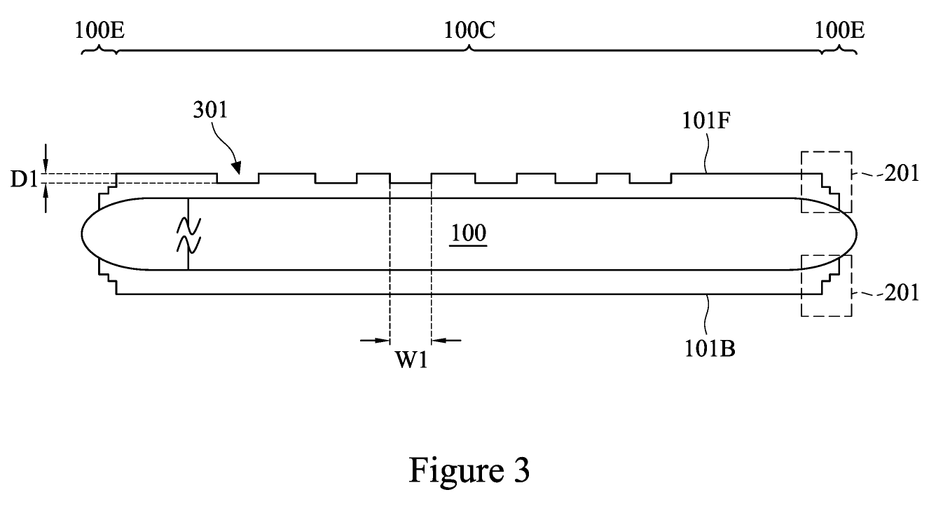

In FIG. 3, recesses 301 are formed in the front-side waveguide cladding layer 101F by a suitable patterning process. The recesses 301 may be formed over only a front-side of the substrate 100. The patterning process may include one or more photolithographic masking and etching processes.

The recesses 301 are each formed to a first depth D1. In some embodiments, the first depth D1 is in the range of 100 nm to 1500 nm (such as about 350 nm or about 600 nm). Additionally, the recesses 301 are each formed to a first width W1. In some embodiments, the first width W1 is in the range of 800 nm to 5000 nm. If the recesses 301 are formed to too large of a depth D1 or too large of a width W1, then the risk of cracking between the front-side waveguide cladding layer 101F and structures subsequently formed in the recesses 301 may be too great. If the recesses 301 are formed to too small of a depth or too small of a width, then the waveguide cores subsequently formed in the recesses 301 may be too small to adequately perform desired functions.

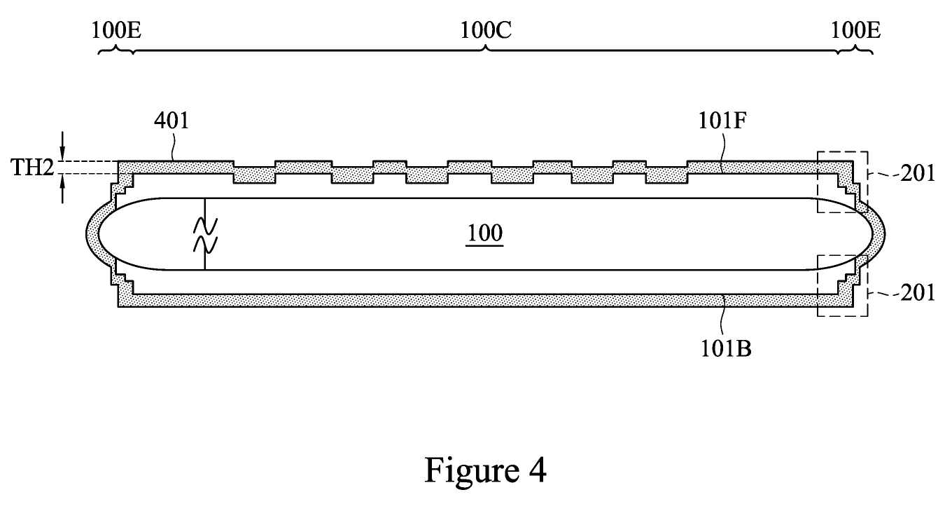

In FIG. 4, a waveguide core layer 401 is formed in the recesses 301 and over the waveguide cladding layers 101. The waveguide core layer 401 extends along the bevel profiles 201 of the waveguide cladding layers 101. The waveguide core layer 401 may be formed of a dielectric material that is suitable for optics. In some embodiments, the waveguide core layer 401 is formed of a nitride dielectric material, such as silicon nitride or the like, which may be formed using a deposition method such as chemical vapor deposition (CVD), atomic layer deposition (ALD), or the like. However, any suitable material and method of manufacture may be used to form the waveguide core layer 401.

The material of the waveguide core layer 401 is different than the material of the waveguide cladding layers 101. Due to the difference in refractive indices of the materials of the waveguide core layer 401 and the waveguide cladding layers 101, the waveguide core layer 401 may have high internal reflections such that light is confined in the waveguide cores during operation, depending on the wavelength of the light and the reflective indices of the respective materials. In an embodiment, the refractive index of the material of the waveguide core layer 401 is higher than the refractive index of the material of the waveguide cladding layers 101.

In some embodiments, the waveguide core layer 401 is formed of silicon nitride. The waveguide core layer 401 is formed to a large thickness TH2. In some embodiments, the waveguide core layer 401 is formed to a thickness TH2 in the range of 150 nm to 3000 nm (such as about 350 nm or about 400 nm). Forming the waveguide core layer 401 of silicon nitride with a large thickness may allow the resulting waveguides to have higher optical confinement and/or lower optical losses. The optical performance of the resulting waveguides may thus be improved. In some embodiments, the material (e.g., silicon nitride) of the waveguide core layer 401 is formed by a low pressure chemical vapor deposition (LPCVD) process. The LPCVD process may be performed such that the waveguide core layer 401 conformally fills (and may overfill) the recesses 301. In some embodiments, the LPCVD process is performed at a pressure in the range of 0.1 Pa to 0.4 Pa. Utilizing a LPCVD process may increase the thickness uniformity of the waveguide core layer 401, even at large thicknesses.

The coefficient of thermal expansion (CTE) of the material of the waveguide core layer 401 may be mismatched with (e.g., significantly different than) the CTE of the material of the waveguide cladding layers 101. When the waveguide core layer 401 includes silicon nitride and the waveguide cladding layers 101 include silicon oxide, the CTE of the waveguide core layer 401 may be greater than the CTE of the waveguide cladding layers 101. In some embodiments, the waveguide core layer 401 has a CTE of about 3.2 ppm/°C, the waveguide cladding layers 101 have a CTE of about 0.5 ppm/°C, and the substrate 100 has a CTE of about 2.6 ppm/°C. The CTE difference between the waveguide core layer 401 and the waveguide cladding layers 101 may be about 2.7 ppm/°C. Stress resulting from a CTE mismatch between the waveguide core layer 401 and the waveguide cladding layers 101 may be stored in the form of elastic energy. Forming the outer edges of the waveguide cladding layers 101 with the bevel profiles 201 helps reduce CTE-induced stress by varying local stress in the waveguide cladding layers 101. Varying local stress in the waveguide cladding layers 101 may affect cracking dynamics, which may reduce the risk of the waveguide cladding layers 101 cracking, even at large thicknesses.

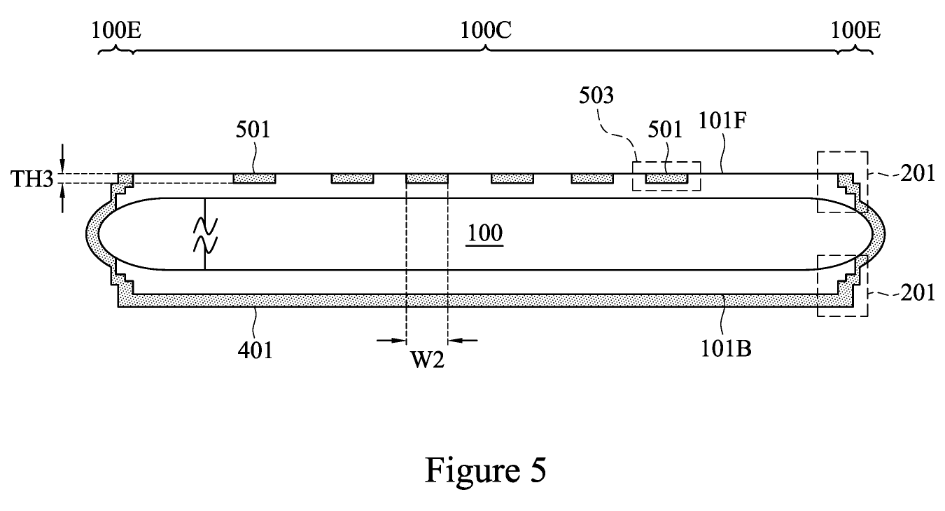

In FIG. 5, a removal process is performed to remove excess portions of the waveguide core layer 401 from outside of the recesses 301 in the front-side waveguide cladding layer 101F, thereby forming waveguide cores 501. The waveguide cores 501 include the remaining portions of the waveguide core layer 401 in the recesses 301. The removal process may be a planarization process, which may planarize a surface of the front-side waveguide cladding layer 101F and the portions of the waveguide core layer 401 in the recesses 301. In some embodiments, the planarization process is a chemical mechanical polish (CMP) process. After the planarization process, a top surface of the front-side waveguide cladding layer 101F may be substantially coplanar (within process variations) with the top surfaces of the waveguide cores 501. However, any suitable process, such as a mechanical process like a grinding process, may be utilized to planarize the material of the waveguide core layer 401 in the recesses 301 with the front-side waveguide cladding layer 101F. After the removal process, the waveguide core layer 401 may remain on the back-side waveguide cladding layer 101B, as well as on the outer edges of the substrate 100 and the front-side waveguide cladding layer 101F. A top surface of the front-side waveguide cladding layer 101F may be substantially coplanar (within process variations) with the portions of the waveguide core layer 401 remaining on the outer edges of the front-side waveguide cladding layer 101F.

The resulting waveguides 503 include the waveguide cores 501 and portions of the front-side waveguide cladding layer 101F. That is, a waveguide 503 includes a waveguide core 501, as well as a surrounding portion of the front-side waveguide cladding layer 101F. A surrounding portion of the front-side waveguide cladding layer 101F may surround a waveguide core 501 on at least three sides in the cross-sectional view. The waveguide cores 501 have a thickness TH3 and a width W2. In some embodiments, the thickness TH3 is in the range of 600 nm to 800 nm, and the width W2 is in the range of 1000 nm to 2500 nm.

In FIG. 6, a back-side removal process 600 is performed to remove the waveguide core layer 401 and the back-side waveguide cladding layer 101B from a back-side of the substrate 100. As a result, the back-side of the substrate 100 is free of the waveguide cladding layers 101. The waveguide core layer 401 may (or may not) also be removed from the outer edges of the substrate 100 and/or the outer edges of the front-side waveguide cladding layer 101F. In some embodiments, the back-side removal process 600 is a wet clean or the like, performed using a suitable cleaning solution. The cleaning solution may include a solvent such as deionized (DI) water, an alkaline solution, an ammonia-based solution (including, e.g., Na, K, C, O, H, or the like), combinations thereof, or the like. The cleaning solution may be dispensed towards the back-side of the substrate 100 while the substrate 100 is rotated to distribute the cleaning solution across the back-side of the substrate 100. The cleaning solution reacts with the waveguide core layer 401 and/or the waveguide cladding layers 101. The cleaning solution used to remove the back-side waveguide cladding layer 101B may be the same or different than the cleaning solution used to remove the waveguide core layer 401. The cleaning solution may cover the back-side of the substrate 100, and may extend up along the outer edges of the substrate 100 during the back-side removal process 600. Additionally, the cleaning solution may extend over the front-side of the substrate 100 by a small amount, such as a distance in the range of 0.8 mm to 2 mm, from the outer edges of the substrate 100.

Following the back-side removal process 600, the waveguides 503 remain at the front-side of the substrate 100, with the waveguide core layer 401 and the back-side waveguide cladding layer 101B having been removed from the back-side of the substrate 100. Further, the front-side waveguide cladding layer 101F remaining over the front-side of the substrate 100 has the bevel profiles 201 following the removal of the portions of the waveguide core layer 401 by the back-side removal process 600.

The waveguides 503 may be used to interconnect the devices of the substrate 100. For example, the substrate 100 may include photonic features. The photonic features transmit and receive optical signals, and convert optical signals to electrical signals. The devices of the substrate 100 may be interconnected by a signal path that includes electrical signals paths (that traverse conductive interconnects) as well as optical signal paths (that traverse the waveguides 503), to form an integrated circuit.

Additional features (not separately illustrated) may be subsequently formed. For example, another waveguide cladding layer may be formed over the waveguide cores 501. The waveguides 503 may further include surrounding portions of the overlying waveguide cladding layer. Additionally, die connectors may be formed for external connections to the integrated circuit of the substrate 100. The die connectors may be adjacent to the waveguides 503, and may extend through the front-side waveguide cladding layer 101F. Likewise, passivation layer(s) may be formed to protect the substrate 100.

The resulting wafer (including the substrate 100 and overlying waveguides 503) may be singulated in subsequent processing to form integrated circuit dies. The singulation process singulates adjacent regions of the wafer from one another. The resulting integrated circuit dies are from the singulated regions of the wafer.

FIG. 7A shows a bevel cleaning module 700, which may be utilized during the bevel process 200 (see FIG. 2A). The bevel cleaning module 700 is used for a wet clean process in this example, but other types of processes could be utilized to perform the bevel process 200 and achieve the bevel profiles 201. The bevel cleaning module 700 includes a chuck 701, a front-side nozzle 703, a back-side nozzle 705, an inlet 707, and an outlet 709. The substrate 100 is held by the chuck 701 within the bevel cleaning module 700. The chuck 701 may be a vacuum chuck which utilizes reduced pressures in order to hold the substrate 100 in place. The chuck 701 holds the substrate 100 in place while the front-side nozzle 703 and the back-side nozzle 705 dispense a cleaning solution on the substrate 100.

The front-side nozzle 703 may be positioned above the substrate 100 held by the chuck 701 and directed to dispense a cleaning solution from an interior of the substrate 100 towards the outer edges of the front-side of the substrate 100. The back-side nozzle 705 may be positioned mirrored to the front-side nozzle 703 beneath the substrate 100 held by the chuck 701 and directed to dispense the cleaning solution from an interior of the substrate 100 towards the outer edges of the back-side of the substrate 100. Multiple etch cycles may be performed, and the positions of the front-side nozzle 703 and the back-side nozzle 705 may be adjusted to change an interface of the cleaning solution with the substrate 100 between each etch cycle.

The inlet 707 is utilized to introduce the cleaning solution. The cleaning solution may include an etchant such as hydrofluoric (HF) acid or the like, suitable for removal of the waveguide cladding layers 101. In some embodiments, the cleaning solution may also include a drying agent such as nitrogen (N₂). However, any suitable cleaning solution may be utilized in the removal of the waveguide cladding layers 101 during the bevel process 200. Further, the outlet 709 may act as a drain where removed portions of the waveguide cladding layers 101 and the cleaning solution may be extracted from the bevel cleaning module 700. The outlet 709 may include an exhaust for process gases.

FIG. 7B shows a simplified process view of the bevel process 200 in the bevel cleaning module 700, in accordance with some embodiments. The chuck 701 holds the substrate 100 while the front-side nozzle 703 and the back-side nozzle 705 dispense a cleaning solution 750 towards the outer edges of the substrate 100 to form bevel profiles 201 (see FIG. 2A) in the outer edges of the waveguide cladding layers 101. In some embodiments, the bevel process 200 removes portions of the waveguide cladding layers 101 in a series of etch cycles, in which the cleaning solution 750 is dispensed in desired locations. The positions of the front-side nozzle 703 and the back-side nozzle 705 may be adjusted between each of the etch cycles so as to interface with the waveguide cladding layers 101 at different positions, thereby reshaping the outer edges of the waveguide cladding layers 101 into desired bevel profiles 201. For example, the front-side nozzle 703 and the back-side nozzle 705 may move further away from the outer edge of the substrate 100 after each etch cycle, or may move closer to the outer edge of the substrate 100 after each etch cycle. In some embodiments, during the bevel process 200, the substrate 100 is held to a process temperature in the range of about 50 °C to about 80 °C. In some embodiments where the bevel profiles 201 are stairstep profiles, an etching depth for each stairstep 203 (e.g., a bevel etching depth) may be in a range of 0.2 mm to 3.0 mm.

Embodiments may achieve advantages. By forming the bevel profiles 201 in the front-side waveguide cladding layer 101F, local stress at the edge portions 100E of the substrate 100 may be reduced, which may mitigate the risk of cracks forming during deposition of the waveguide core layer 401 with a large thickness. As a result, the waveguide core layer 401 may be deposited to a large thickness in a single deposition process, simplifying the manufacturing process and reducing processing costs associated with multi-step deposition processes. The optical performance and yield of the waveguides 503 may thus be improved. Specifically, the waveguide cores 501 having a large thickness may allow the resulting waveguides 503 to have higher optical confinement and/or lower optical losses.

In an embodiment, a method includes: depositing a waveguide cladding layer over a substrate, the substrate having a center portion in a cross-sectional view and an edge portion adjacent the center portion in the cross-sectional view; reshaping the waveguide cladding layer to form a bevel profile in the waveguide cladding layer over the edge portion of the substrate; forming a recess in the waveguide cladding layer; depositing a waveguide core layer in the recess and over the waveguide cladding layer, the waveguide core layer extending along the bevel profile of the waveguide cladding layer; and planarizing the waveguide core layer and the waveguide cladding layer to form a waveguide core, the waveguide core including a portion of the waveguide core layer in the recess. In some embodiments of the method, the waveguide core layer is deposited by a low pressure chemical vapor deposition process. In some embodiments of the method, the waveguide cladding layer is formed of silicon oxide and the waveguide core layer is formed of silicon nitride. In some embodiments of the method, during the reshaping of the waveguide cladding layer, the substrate is maintained at a temperature between 50 °C to 80 °C. In some embodiments of the method, reshaping the waveguide cladding layer includes performing a series of etch cycles using an etchant, an interface between the etchant and the waveguide cladding layer being changed between each of the etch cycles. In some embodiments of the method, the bevel profile is a stairstep profile. In some embodiments of the method, the waveguide core layer has a thickness in a range of 150 nm to 3000 nm.

In an embodiment, a method includes: forming a front-side waveguide cladding layer over a substrate, an outer edge of the front-side waveguide cladding layer having a first bevel profile, the front-side waveguide cladding layer including a first material; forming a recess in the front-side waveguide cladding layer; and forming a waveguide core in the recess, a top surface of the waveguide core being substantially coplanar with a top surface of the front-side waveguide cladding layer, the waveguide core including a second material, the second material having a higher refractive index than the first material. In some embodiments of the method, the first bevel profile is a stairstep profile including a plurality of stairsteps, each of the stairsteps having a different bevel depth. In some embodiments, the method further includes: forming a back-side waveguide cladding layer over the substrate, an outer edge of the back-side waveguide cladding layer having a second bevel profile. In some embodiments of the method, the front-side waveguide cladding layer has a first bevel depth measured from the outer edge of the substrate, the back-side waveguide cladding layer has a second bevel depth measured from the outer edge of the substrate, and the first bevel depth is substantially equal to the second bevel depth. In some embodiments of the method, the front-side waveguide cladding layer has a first bevel depth measured from the outer edge of the substrate, the back-side waveguide cladding layer has a second bevel depth measured from the outer edge of the substrate, and the first bevel depth is different than the second bevel depth. In some embodiments, the method further includes: removing the back-side waveguide cladding layer from the substrate while the front-side waveguide cladding layer remains over the substrate.

In an embodiment, a device includes: a substrate having an edge portion with a rounded shape in a cross-sectional view; a waveguide cladding layer over a front-side of the substrate, an outer edge of the waveguide cladding layer having a bevel profile, the bevel profile overlapping the edge portion of the substrate with the rounded shape; and a waveguide core in the waveguide cladding layer, a top surface of the waveguide core being substantially coplanar with a top surface of the waveguide cladding layer. In some embodiments of the device, the bevel profile is a stairstep profile. In some embodiments of the device, the stairstep profile includes stairsteps, each of the stairsteps having a different bevel depth measured from an outer edge of the substrate. In some embodiments of the device, the waveguide core has a thickness in a range of 600 nm to 800 nm. In some embodiments of the device, a back-side of the substrate is free of waveguide cladding layers. In some embodiments of the device, the waveguide cladding layer includes a first material, the waveguide core includes a second material, and the second material has a higher refractive index than the first material. In some embodiments of the device, the first material is silicon oxide and the second material is silicon nitride.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device comprising:
a substrate comprising devices and interconnects at a front-side of the substrate, the substrate having a rounded outer edge;
a first waveguide cladding layer on the front-side of the substrate, the first waveguide cladding layer having an outer edge with a stairstep profile, the stairstep profile comprising stairsteps that overlap the rounded outer edge of the substrate;
a waveguide core in the first waveguide cladding layer, the waveguide core and a surrounding portion of the first waveguide cladding layer being part of a waveguide, the devices being interconnected by a signal path to form an integrated circuit, the signal path comprising an electrical signal path through the interconnects and an optical signal path through the waveguide; and
a dielectric layer on the outer edge of the first waveguide cladding layer, the dielectric layer extending along the stairsteps, the dielectric layer comprising a same material as the waveguide core, the dielectric layer being separated from the waveguide core.

2. The device of claim 1, wherein each of the stairsteps has a respective bevel depth, wherein each respective bevel depth increases in a direction extending away from the substrate.

3. The device of claim 1, wherein the dielectric layer comprises a material having a refractive index that is greater than a refractive index of a material of the first waveguide cladding layer.

4. The device of claim 1, wherein the dielectric layer comprises a material having a coefficient of thermal expansion that is greater than a coefficient of thermal expansion of a material of the first waveguide cladding layer.

5. The device of claim 1, wherein a top surface of the dielectric layer is coplanar with a top surface of the first waveguide cladding layer and with a top surface of the waveguide core.

6. The device of claim 1, wherein the rounded outer edge of the substrate extends laterally beyond the outer edge of the first waveguide cladding layer.

7. The device of claim 1, further comprising:
a second waveguide cladding layer on the waveguide core, the waveguide further comprising a surrounding portion of the second waveguide cladding layer.

8. The device of claim 1, further comprising:
a die connector for external connection to the integrated circuit, the die connector disposed adjacent to the waveguide, the die connector extending through the first waveguide cladding layer.

9. A device comprising:
a substrate having an edge portion with a rounded shape in a cross-sectional view;
a waveguide cladding layer over a front-side of the substrate, an outer edge of the waveguide cladding layer having a bevel profile, the bevel profile overlapping the edge portion of the substrate with the rounded shape; and
a waveguide core in the waveguide cladding layer, a top surface of the waveguide core being substantially coplanar with a top surface of the waveguide cladding layer.

10. The device of claim 9, wherein the bevel profile is a stairstep profile.

11. The device of claim 10, wherein the stairstep profile comprises stairsteps, each of the stairsteps having a different bevel depth measured from an outer edge of the substrate.

12. The device of claim 9, wherein the waveguide core has a thickness in a range of 600 nm to 800 nm.

13. The device of claim 9, wherein a back-side of the substrate is free of waveguide cladding layers.

14. The device of claim 9, wherein the waveguide cladding layer comprises a first material, the waveguide core comprises a second material, and the second material has a higher refractive index than the first material.

15. The device of claim 14, wherein the first material is silicon oxide and the second material is silicon nitride.

16. The device of claim 9, wherein the waveguide core and a surrounding portion of the waveguide cladding layer are part of a waveguide, the substrate comprises a photonic feature, and the photonic feature is configured to transmit and receive optical signals that traverse the waveguide.

17. A device comprising:
a substrate comprising devices and interconnects at a front-side of the substrate, the substrate having an edge portion with a rounded shape in a cross-sectional view;
a waveguide cladding layer on the front-side of the substrate, an outer edge of the waveguide cladding layer having a bevel profile, the bevel profile comprising stairsteps that overlap the edge portion of the substrate with the rounded shape;
a waveguide core in the waveguide cladding layer, a top surface of the waveguide core being substantially coplanar with a top surface of the waveguide cladding layer, the waveguide core and a surrounding portion of the waveguide cladding layer being part of a waveguide, the devices being interconnected by a signal path to form an integrated circuit, the signal path comprising an electrical signal path through the interconnects and an optical signal path through the waveguide; and
a dielectric layer on the outer edge of the waveguide cladding layer, the dielectric layer extending along the stairsteps, the dielectric layer comprising a same material as the waveguide core, the dielectric layer being separated from the waveguide core.

18. The device of claim 17, wherein each of the stairsteps has a different bevel depth measured from an outer edge of the substrate.

19. The device of claim 17, wherein a back-side of the substrate is free of waveguide cladding layers.

20. The device of claim 17, wherein the waveguide cladding layer comprises a first material, the waveguide core comprises a second material, the dielectric layer comprises the second material, and the second material has a higher refractive index than the first material.
